(19) United States
(12) Patent Application Publication
(10) Pub. No.: US 2002/0198305 A1
(43) Pub. Date: Dec. 26, 2002

(54) Filled elastomeric compositions

(76) Inventor: William Hopkins, Sarnia (CA)

Correspondence Address: BAYER CORPORATION, PATENT DEPARTMENT, 100 BAYER ROAD, PITTSBURGH, PA, 15205, US

(21) Appl. No.: 10/086,000

(22) Filed: Feb. 28, 2002

(30) Foreign Application Priority Data
Mar. 2, 2001 (CA) 2,339,056

(51) Int. Cl. C08K 3/34

(52) U.S. Cl. 524/492

(57) ABSTRACT

Elastomeric compositions comprising natural rubber, halobutyl elastomer, a mineral filler and a bonding agent display improved properties useful, for example, in vehicle tire treads.

### FIELD OF THE INVENTION

The present invention relates to filled elastomeric compositions, to processes for making filled elastomeric compositions and to their use.

### BACKGROUND OF THE INVENTION

Natural rubbers are known to be useful for many purposes, one of which is in vehicle tire treads, especially for truck tires. Many properties are desirable in a rubber used in a vehicle tire tread and generally improvements in one property are achieved at the expense of other properties. It is desirable that rubber for tire treads display good wet traction, good wear characteristics and low rolling resistance. Wet traction correlates with tan δ at 0°. Wear characteristics are measured by the DIN (Deutsche Industrie Norm) abrasion test. Rolling resistance correlates with tan δ or E″ at 60° C. The present invention provides compositions in which one or more of these properties can be enhanced without significant deleterious effect on the other.

### SUMMARY OF THE INVENTION

The present invention provides an elastomeric composition containing a natural rubber, a halobutyl rubber, a mineral filler, and a rubber-mineral filler-bonding agent.

The present invention also provides a process for preparing an elastomeric composition which includes blending a natural rubber and a halobutyl rubber with a mineral filler, then blending the resulting composition with a rubber-mineral filler bonding agent.

### BRIEF DESCRIPTION OF THE DRAWINGS

FIG. 1 illustrates the effect of the addition of BB2040 to natural rubber on abrasion and tan δ at 0° C.

FIG. 2 illustrates the effect of the addition of BB2040 to natural rubber on the dynamic properties.

### DETAILED DESCRIPTION OF THE INVENTION

The elastomeric composition of the present invention is composed of natural rubber and a halobutyl elastomer, and with a mineral filler. Co-pending U.S. patent application Ser. No. 09/742,797, published as US-2001-0009948-A1 on Jul. 26, 2001, provides for a halobutyl elastomer filled with a mineral filler and preferably the halobutyl elastomer used in the present invention is in accordance with application Ser. No. 09/742,797, the disclosure of which is incorporated by reference.

Accordingly, in a preferred embodiment of this invention the elastomeric composition contains a blend of: (i) natural rubber and (ii) a halobutyl elastomer (iii) a mineral filler, preferably silica, and (iv) a bonding agent, preferably a silane that has at least one hydroxyl group or hydrolyzable group attached to the silicon atom of the silane, wherein the elastomeric composition is cured with sulfur.

Natural rubber and halobutyl rubber are oleophilic. Minerals that are fillers also tend to be oleophobic. However, it is difficult to achieve good mixing of oleophobic particles and oleophilic rubbers, therefore one solution to this problem is to incorporate an agent, referred to herein as a bonding agent, in the rubber-filler mixture. The bonding agent can be a silane or mixture of silanes. The preferred silane has at least one hydroxyl group or hydrolyzable group attached to the silicon of the silane. Suitable silanes that can be used include an aminosilane, particularly an aminosilane as described in PCT International Application PCT/CA98/00499, published on Nov. 26, 1998 as WO98/53004, or a sulfur-containing silane as described in U.S. Pat. No. 4,704,414, published European Patent Application No. 0 670 347 A1 or published German Patent Application No. 4,435,311 A1, the disclosures of which are incorporated by reference. It is of course possible to use a mixture of carbon black filler and mineral filler. Mineral fillers are discussed in greater detail below.

The halobutyl elastomer and natural rubber used in the present invention may be in a mixture with one or more additional elastomers or elastomeric compounds. The halobutyl elastomer should constitute more than 5% of any such mixture. However, in some cases it is preferred not to use additional elastomers but to use the halobutyl elastomer and natural rubber as the sole elastomers. If additional elastomers are to be used, the additional elastomer may be, for example, polybutadiene, styrenebutadiene or poly-chloroprene or an elastomer compound containing a mixture thereof.

Compositions containing only natural rubber and halobutyl rubber as the elastomers, and in which the halobutyl elastomer constitutes from 5 to 50%, particularly 5 to 30% of the elastomeric content are preferred.

Compositions of the present invention containing rubber, the halogenated butyl elastomer and the mineral filler can be cured to obtain a cured product that displays improved properties, for instance in abrasion resistance, rolling resistance and traction. Curing may be effected with sulfur. The preferred amount of sulfur is 0.3 to 2.0 parts by weight per hundred parts of rubber. Optionally an activator, for example zinc oxide may be used. If zinc oxide is present it may be present in an amount up to 5 parts, preferably up to 2 parts, by weight. Other ingredients, for instance stearic acid, or antioxidants, or accelerators may also be added to the elastomer prior to curing. Sulfur curing is then effected in any known manner. See, for instance, chapter 2, “The Compounding and Vulcanization of Rubber”, of “Rubber Technology”, 3^{rd} edition, published by Chapman & Hall, 1995, the disclosure of which is incorporated by reference.

The present invention also provides a sulfur-cured composition containing natural rubber and a halogenated elastomer, optionally containing additional elastomers or elastomeric compounds a filler and a bonding agent prepared by the processes described above.

The phrase “halogenated butyl elastomer” as used herein refers to a chlorinated or brominated butyl elastomer. Brominated elastomers are preferred and the present invention is further described, by way of example, with reference to brominated elastomers. It should be understood, however, that the invention extends to use of a chlorinated butyl elastomer, and references to brominated butyl elastomer should be construed as extending to chlorinated butyl elastomer unless the context clearly requires otherwise.

Brominated butyl elastomers suitable for use in this invention can be obtained by bromination of butyl rubber which is a copolymer of isobutylene and a comonomer that is usually a C₄ to C₆ conjugated diolefin, preferably isoprene. Comonomers other than conjugated diolefins can be used, however, and mention is made of alkyl-substituted vinyl aromatic comonomers such as C₁-C₄-alkyl substituted styrene. One example that is commercially available is brominated isobutylene methylstyrene copolymer (BIMS) in which the comonomer is p-methylstyrene.

A brominated butyl elastomer typically contains from about 1 to about 3 weight percent of isoprene and from about 97 to about 99 weight percent of isobutylene based on the hydrocarbon content of the polymer, and from about 1 to about 4 weight percent bromine based on the bromobutyl polymer. A typical bromobutyl polymer has a molecular weight, expressed as the Mooney viscosity (ML 1+8 at 125° C.), of from about 28 to about 55.

For use in the present invention the brominated butyl elastomer preferably contains from about 1 to about 2 weight percent of isoprene and from about 98 to 99 weight percent of isobutylene based on the hydrocarbon content of the polymer and from about 0.5 to about 2.5 weight percent, preferably from about 0.75 to about 2.3 weight percent, of bromine based on the brominated butyl polymer.

Optionally, a stabilizer may be added to the brominated butyl elastomer. Suitable stabilizers include calcium stearate and epoxidized soybean oil, preferably used in an amount of from about 0.5 to about 5 parts by weight per 100 parts by weight of the brominated butyl rubber.

Examples of suitable brominated butyl elastomers include Bayer Bromobutyl BB2040, commercially available from Bayer. Bayer Bromobutyl BB2040 has a Mooney viscosity (RPML 1+8@125° C.) of 39±4, a bromine content of 2.0±0.3 wt % and an approximate molecular weight of 500,000 grams per mole. Examples of suitable chlorinated butyl elastomers include Bayer Chlorobutyl CB1240, also commercially available from Bayer. Bayer Chlorobutyl CB1240 has a Mooney viscosity (RPML 1+8@125° C.) of 38±4 and a chlorine content of 1.25±0.1 wt %.

The filler used in the blend of the present invention contains particles of a mineral, including silica, silicates, clay such as bentonite, gypsum, alumina, titanium dioxide, talc, mixtures thereof. These mineral particles have hydroxyl groups on their surface, rendering them hydrophilic and oleophobic. This exacerbates the difficulty of achieving good interaction between the filler particles and the elastomer. The preferred mineral is silica, preferably silica made by carbon dioxide precipitation of sodium silicate.

Dried amorphous silica particles suitable for use in the elastomeric composition of the present invention may have a mean agglomerate particle size between 1 and 100 microns, preferably between 10 and 50 microns and more preferably between 10 and 25 microns. It is preferred that less than 10 percent by volume of the agglomerate particles are below 5 microns or over 50 microns in size. A suitable amorphous dried silica has a BET surface area, measured in accordance with DIN (Deutsche Industrie Norm) 66131, of between 50 and 450 square meters per gram and a DBP absorption, as measured in accordance with DIN 53601, of between 150 and 400 grams per 100 grams of silica, and a drying loss, as measured according to DIN ISO 787/11, of from 0 to 10 percent by weight. Suitable silica fillers are available under the trademarks HiSil 210, HiSil 233 and HiSil 243 from PPG Industries Inc. Also suitable are Vulkasil S and Vulkasil N, from Bayer AG.

The silane used in the process has a hydroxyl group or a hydrolyzable group that is attached to the silicon atom of the silane. The hydrolyzable group can be regarded as a hydroxyl group that is produced in situ from a silane that has a silicon atom that bears a group that will undergo hydrolysis to yield a hydroxyl group on the silicon. Examples of such hydrolyzable groups include alkoxy groups having up to six carbon atoms, especially ethoxy and methoxy groups. These and other hydrolyzable groups are discussed further below.

The silane used in accordance with the present invention is preferably an aminosilane or a sulfur-containing silane. More preferably aminosilanes of formula I defined in our PCT international application PCT/CA98/00499, published on Nov. 26, 1998 as WO98/53004, the disclosure of which is incorporated herein by reference, and acid addition salts and quaternary ammonium salts of such aminosilanes.

Formula I of PCT/CA98100499 is as follows:

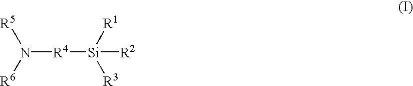

in which:

at least one of R¹, R² and R³, preferably two of R¹, R² and R³ and most preferably three of R¹, R² and R³ are hydroxyl or hydrolyzable groups;

R⁴ is a divalent group that is resistant to hydrolysis at the Si—R⁴ bond;

R⁵ is selected from the group consisting of hydrogen; a C₁₋₄₀ alkyl group; a C₂₋₄₀ mono-, di- or tri-unsaturated alkenyl group; a C₆-C₄₀ aryl group; a group of the formula:

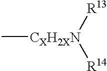

in which x is an integer from 2 to 10, R¹³ and R¹⁴, which may be the same or different, are each hydrogen; C₁₋₁₈ alkyl; C₂₋₁₈ mono-, di- or tri-unsaturated alkenyl; phenyl; a group of the formula:

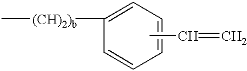

wherein b is an integer from 1 to 10; a group of formula:

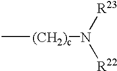

wherein c is an integer from 1 to 10 and R²² and R²³ which may be the same or different, are each hydrogen, a C₁₋₁₀ alkyl group or C₂₋₁₀ alkenyl group, provided that there is no double bond in the position alpha to the nitrogen atom; a group of the formula:

—[(CH₂)ᵣNH]_{d}—H

wherein r is an integer from 1 to 6 and d is an integer from 1 to 4; R⁶ may be any of the groups defined for R⁵, or R⁵ and R⁶ may together form a divalent group of formula:

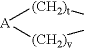

in which A is selected from the group consisting of an oxygen atom and a sulfur atom, —CHR groups and or —NR groups in which R is hydrogen or a C₁₋₄₀ alkyl or C₂₋₄₀ alkenyl group, a C₆-C₄₀ aryl group, and t and v are each independently 1, 2, 3 or 4; provided that the sum of t and v does not exceed 6, and is preferably 4.

In the aminosilane of formula I, it is preferred that all three of the groups R¹, R² and R³ are readily hydrolyzable. Suitable groups R¹ include hydroxyl groups and hydrolyzable groups of formula OCₚH₂ₚ+1, where p has a value from 1 to 10. The alkyl chain can be interrupted by oxygen atoms, to give groups, for example, of formula CH₃OCH₂O—, CH₃OCH₂OCH₂O—, CH₃(OCH₂)₄O—, CH₃OCH₂CH₂O—, C₂H₅OCH₂O—, C₂H₅OCH₂OCH₂O—, or C₂H₅OCH₂CH₂O—. Other suitable hydrolyzable groups include phenoxy, acetoxy, chloro, bromo, iodo, ONa, OLi, OK or amino or mono- or dialkylamino, wherein the alkyl group(s) have 1 to 30 carbon atoms.

R² and R³ can take the same values as R¹, provided that only one of R¹, R² and R³ is chloro, bromo or iodo. Preferably, only one or two of R¹, R² and R³ is hydroxyl or ONa, OLi or OK.

Non-limiting examples of groups R² and R³ that are not hydrolyzable include C₁₋₁₀ alkyl, C₂₋₁₀ mono- or diunsaturated alkenyl, and phenyl. R² and R³ can also be a group —R⁴NR⁵R⁶, discussed further below. It is preferred that R¹, R² and R³ are all the same and are CH₃O—, C₂H₅O— or C₃H₈O—. More preferably they are all CH₃O— or C₂H₅O—.

The divalent group R⁴ is preferably such that N—R⁴—Si is one of the formula:

N—(CH₂)ₚ(O)ₒ(C₆H₄)ₙ(CH₂)ₘ(CH═CH)ₖ—Si

in which k, m, n, o and p are all whole numbers. The order of the moieties between N and Si is not particularly restricted, other than that neither N or o should be directly bound to Si. The value of k is 0 or 1, the value of m is from 0 to 20 inclusive, the value of n is 0, 1 or 2, the value of o is 0 or 1 and the value of p is from 0 to 20 inclusive, with the provisos that the sum of the values of k, m, n, o and p is at least 1 and not more than 20 and that if o is 1, p is 1 or greater and the sum of k, m and n is 1 or greater, i.e. that the Si atom is linked directly to a carbon atom. There should be no hydrolyzable bond between the silicon and nitrogen atoms. Preferably, m is 3 and 1, n, o and p are all 0, i.e., R⁴ is —CH₂CH₂CH₂—.

The group R⁵ is preferably a C₈₋₂₀ mono-unsaturated alkenyl group, most preferably a C₁₆₋₁₈ monounsaturated alkenyl group. R⁶ is preferably hydrogen.

Suitable aminosilanes of Formula I include, but are not limited to: 3-aminopropylmethyldiethoxysilane, N-2-(vinylbenzylamino)-ethyl-3-aminopropyl-trimethoxysilane, N-(2-aminoethyl)-3 aminopropyl-trimethoxysilane, trimethoxysilylpropyldiethylenetriamine, N-2-(aminoethyl)-3 aminopropyltris(2-ethylhexoxy)-silane, 3-aminopropyl-diisopropylethoxysilane, N-(6-aminohexy)aminopropyltrimethoxysilane, 4-aminobutyltriethoxysilane, 4-aminobutyldimethylmethoxysilane, triethoxysilylpropyl-diethylenetriamine, 3-aminopropyltris-(methoxyethoxyethoxy)silane, N-(2-aminoethyl)-3-aminopropyltrimethoxysilane, N-2-(aminoethyl)-3-aminopropyltris(2-ethylhexoxy)-silane, 3-aminopropyl-diisopropylethoxysilane, N-(6-aminohexyl)aminopropyltrimethoxysilane, 4-aminobutyltriethoxysilane, and(cyclohexylaminomethyl)-methyl-diethoxysilane.

Preferred compounds of formula I include those in which R⁵ is hydrogen and R⁶ is the alkenyl group from the following: soy alkyl, tall oil alkyl, stearyl, tallow alkyl, dihydrogenated tallow alkyl, cocoalkyl, rosin alkyl, and palmityl, it being understood that in this case the alkyl may include unsaturation.

It is preferred that at least one of R⁴, R¹³ and R¹⁴ has a chain of at least 8 carbon atoms, more preferably at least 10 carbon atoms, uninterrupted by any heteroatom.

The aminosilane of formula I can be used as the free base, or in the form of its acid addition or quaternary ammonium salt, i.e.

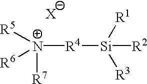

wherein R¹, R², R³, R⁴, R⁵ and R⁶ are as defined above; R⁷ is selected from the group consisting of hydrogen, C₁₋₄₀ alkyl groups and C₂₋₄₀ mono-, di- or triunsaturated alkenyl groups, and X is an anion. X is suitably chlorine, bromine, or sulphate, of which chlorine and bromine are preferred, and R⁷ is preferably hydrogen.

Non-limiting examples of suitable salts of aminosilanes of formula I include N-oleyl-N-[(3-triethoxysilyl)propyl]ammonium chloride, N-3-aminopropylmethyldiethoxy-silane hydrobromide, (aminoethylaminomethyl)phenyltrimethoxysilane hydrochloride, N-[(3-trimethoxysilyl)propyl]-N-methyl, N-N-diallylammonium chloride, N-tetradecyl-N,N-dimethyl-N-[(3-trimethoxysilyl)propyl]ammonium bromide, 3[2-N-benzyl-aminoethyl-aminopropyl]trimethoxysilane hydrochloride, N-octadecyl-N,N-dimethyl-N-[(3-tri-methoxysilyl) propyl]ammonium bromide, N-[(trimeth-oxysilyl)propyl]-N-tri(n-butyl)ammonium chloride, N-octadecyl-N-[3-triethoxysilyl)propyl]ammonium chloride, N-2-(vinylbenzylamino)ethyl-3-aminopropyl-trimethoxysilane hydrochloride, N-2-(vinylbenzylamino)ethyl-3-aminopropyl-trimethoxysilane hydrochloride and N-oleyl-N-[(3-trimeth-oxysilyl)propyl]ammonium chloride.

The silane compound may be a sulfur-containing silane compound. Suitable sulfur-containing silanes include those described in U.S. Pat. No. 4,704,414, in published European patent application 0,670,347 A1 and in published German patent application 4435311 A1, the disclosures of each of which is incorporated herein by reference. One suitable compound is a mixture of bis[3-(triethoxysilyl)propyl]-monosulfane, bis[3-(triethoxysilyl)propyl] disulfane, bis[3-(triethoxysilyl)propyl]trisulfane and bis[3-(triethoxysilyl)propyl]tetrasulfane and higher sulfane homologues available under the trademarks Si-69 (average sulfane 3.5), Silquest™ A-1589 (from CK Witco) or Si-75 (from Degussa) (average sulfane 2.0). Another example is bis[2-(triethoxysilyl)ethyl]-tetrasulfane, available under the trademark Silquest RC-2.

Examples of suitable sulfur-containing silanes include compounds of formula

R⁸R⁹R¹⁰SiR¹¹

in which at least one of R⁸, R⁹ and R¹⁰, preferably two of R⁸, R⁹ and R¹⁰ and most preferably three of R⁸, R⁹ and R¹⁰, are hydroxyl or hydrolyzable groups. The groups R⁸, R⁹ and R¹⁰ are bound to the silicon atom. The group R⁸ may be hydroxyl or OCₚH₂ₚ+1 where p is from 1 to 10 and the carbon chain may be interrupted by oxygen atoms, to give groups, for example of formula CH₃OCH₂O—, CH₃OCH₂OCH₂O—, CH₃(OCH₂)₄O—, CH₃OCH₂O—, C₂H₅OCH₂O—, C₂H₅OCH₂OCH₂O—, or C₂H₅OCH₂CH₂O—. Alternatively, R⁸ may be phenoxy. The group R⁹ may be the same as R⁸. R⁹ may also be a C₁₁₀ alkyl group, or a C₂₋₁₀ mono- or diunsaturated alkenyl group. Further, R⁹ may be the same as the group R¹¹ described below.

R¹⁰ may be the same as R⁸, but it is preferred that R⁸, R⁹ and R¹⁰ are not all hydroxyl. R¹⁰ may also be C₁₋₁₀ alkyl, phenyl, C₂₋₁₀ mono- or diunsaturated alkenyl. Further, R¹⁰ may be the same as the group R¹ 1 described below.

The group R¹¹ attached to the silicon atom is such that it may participate in a crosslinking reaction with unsaturated polymers by contributing to the formation of crosslinks or by otherwise participating in crosslinking. R¹¹ may have the following structure:

-(alk)ₑ(Ar)_{f}Sᵢ(alk)_{g}(Ar)ₕSiR⁸R⁹R¹⁰

wherein R⁸, R⁹ and R¹⁰ are the same as previously defined, alk is a divalent straight hydrocarbon group having between 1 and 6 carbon atoms or a branched hydrocarbon group having between 2 and 6 carbon atoms, Ar is either a phenylene —C₆H₄—, biphenylene —C₆H₄—C₆H₄— or —C₆H₄— OC₆H4— group and e, f, g and h are either 0, 1 or 2 and i is an integer from 2 to 8 inclusive with the provisos that the sum of e and f is always 1 or greater than 1 and that the sum of g and h is also always 1 or greater than 1. Alternately, R¹¹ may be represented by the structures (alk)ₑ(Ar)_{f}SH or (alk)ₑ(Ar)_{f}SCN where e and f are as defined previously.

Preferably, R⁸, R⁹ and R¹⁰ are all either OCH₃, OC₂H₅ or OC₃H₈ groups and most preferably all are OCH₃ or OC₂H₅ groups. It is most preferred that the sulfur-containing silane is bis[3-(trimethoxysilyl)propyl]-tetrasulfane (Si-168).

Non-limiting illustrative examples of other sulfur-containing silanes include the following: bis[3-(triethoxysilyl)propyl]disulfane, bis[2-(trimethoxysilyl)ethyl]tetrasulfane, bis[2-(triethoxysilyl)ethyl]trisulfane, bis[3-(trimethoxysilyl)propyl]disulfane, 3-mercaptopropyltrimethoxysilane, 3-mercaptopropylmethyldiethoxysilane, and 3-mercaptoethylpropylethoxymethoxysilane.

Other preferred sulfur-containing silanes include those disclosed in published German patent application 44 35 311 A1, the disclosure of which is incorporated by reference. On pages 2 and 3, there is disclosure of oligomers and polymers of sulfur containing organooxysilanes of the general formula:

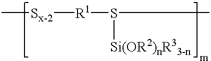

in which R¹ is a saturated or unsaturated, branched or unbranched, substituted or unsubstituted hydrocarbon group that is at least trivalent and has from 2 to 20 carbon atoms, provided that there are at least two carbon-sulfur bonds, R² and R³, independently of each other, are saturated or unsaturated, branched or unbranched, substituted or unsubstituted hydrocarbon groups with 1 to 20 carbon atoms, halogen, hydroxy or hydrogen, n is 1 to 3, m is 1 to 1000, p is 1 to 5, q is 1 to 3 and x is 1 to 8.

Other sulfur-containing silanes are of the general formula

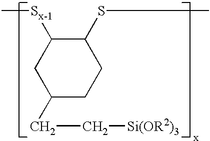

wherein R², m and x have the meanings given above, and R² is preferably methyl or ethyl. These compounds disclosed are in German Patent Application No. 44 35 311 A1.

Particularly preferred sulfur-containing silanes are those of the following general formulae:

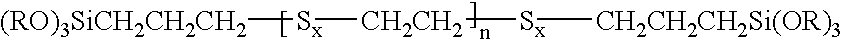

in which R=—CH₃ or —C₂H₅, x=1-6 and n=1-10;

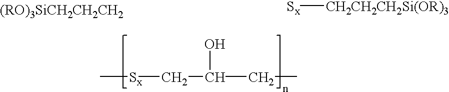

in which R=—CH₃ or —C₂H₅, x=1-6 and n=1-10;

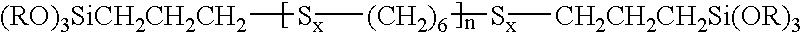

in which R=—CH₃, —C₂H₅ or —C₃H₇, n=1-10 and x=1-6;

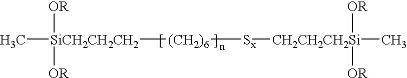

in which R=—CH₃, —C₂H₅ or—C₃H₇, n=1-10 and x=1-6;

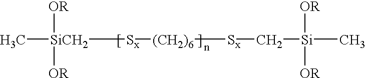

in which R=—CH₃, —C₂H₅, —C₃H₇, n=1-10 and x=1-6;

(RO)₃Si—CH₂CH₂CH₂[Sₓ—CH₂CH₂OCH₂CH₂]ₙSₓ—CH₂H₂CH₂Si(OR)₃

n which R=—CH₃, —C₂H₅, —C₃H₇, n=1-10 and x=1-6;

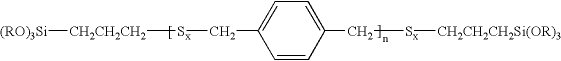

in which R=—CH₃, —C₂H₅ or —C₃H₇, n=1-10 and x=1-6;

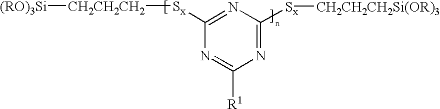

in which R=—CH₃, —C₂H₅ or —C₃H₇; R¹=—CH₃, —C₂H₅, —C₃H₇, —C₅H₅, —OCH₃, —OC₂H₅, —OC₃H₇ or —OC₅H₅, n=1-10 and x=1-8; and

(RO)₃Si—CH₂CH₂CH₂[Sₓ—(CH₂)₆][Sₓ(CH₂)₆]ₚCH₂CH₂Si(OR)₃

in which R=—CH₃, —C₂H₅ or —C₃H₇, r+p=2-10 and x=1-6.

Also mentioned are sulfur-containing silanes of the formulae:

(RO)₃Si—CH₂CH₂CH₂[Sₓ—(CH₂CH₂)₆]Sₓ—CH₂CH₂CH₂—Si(OR)₃

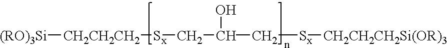

in which x is 1-6 and n is 1-4.

If the silane is a sulfur-containing silane a preferred silane is bis[3-(triethoxysilyl)propyl]-tetrasulfane, of formula

(C₂H₅O)₃Si—CH₂—CH₂—CH₂—S—S—S—S—CH₂—CH₂—CH₂—Si(OC₂H₅)₃.

This compound is commercially available under the trademark Si-69. In fact Si-69 is a mixture of the above compound, i.e., the tetrasulfane, with bis[3-(triethoxy-silyl)-propyl]monosulfane and bis[3-(triethoxysilyl)-propyl]trisulfane, average sulfane 3.5.

Another preferred sulfur-containing silane is available under the trademark Silquest 1589. The material available under this trademark is a mixture of sulfanes but the predominant component, about 75%, is similar in structure to the tetrasulfane Si-69, except that it is a disulfane, i.e., it has only

—S—S—

where Si-69 has

—S—S—S—S—.

The remainder of the mixture is composed of —S₁ to —S₇-compounds. Silquest A-1 589 is available from CK Witco. A similar 15 material is available from Degussa under the trademark Si-75.

Yet another preferred sulfur-containing silane is bis[2-(triethoxysilyl)ethyl]tetrasulfane, available under the trademark Silquest RC-2.

The trimethoxy compounds corresponding to these triethoxy compounds can also be used.

The amount of filler to be incorporated into the elastomeric composition can be varied between wide limits. Typical amounts of filler are about 20 parts to about 120 parts by weight, preferably 30 parts to 100 parts, more preferably 40 to 80 parts per hundred parts of elastomer. The amount of the silane compound or compounds used may be about 2 to 12 parts, preferably 6 to 10 parts, per hundred parts of filler. There may also be present up to about 40 parts of processing oil, preferably 5 to 20 parts, per hundred parts of elastomer, and a lubricant, for example a fatty acid such as stearic acid up to about 3 parts by weight, preferably up to 2 parts by weight.

Carbon black is not normally used as a filler in the elastomer compositions of the present invention, but in some embodiments it may be present in an amount up to about 40 phr. If the mineral filler is silica and it is used with carbon black, the silica should constitute at least 55% by weight of the total of silica and carbon black. If the halobutyl elastomer/natural rubber composition of the present invention is blended with additional elastomeric composition, the additional elastomeric composition may contain carbon black as a filler, or it may contain mineral filler, or it may be unfilled until it is blended with the other components of the composition.

The butyl elastomer, natural rubber filler and silane can be mixed together, suitably at an elevated temperature that may range from about 30° C. to about 200° C. It is preferred that the temperature is greater than about 60° C., and a temperature in the range 90 to 160° C. is particularly preferred. Normally the mixing time does not exceed about one hour and a time in the range from about 2 to 30 minutes is usually adequate. The mixing is suitably carried out in an internal mixer such as a Banbury mixer, or a Haake or Brabender miniature internal mixer. A two-roll mill mixer also provides a good dispersion of the filler within the elastomeric composition. An extruder also provides good mixing, and permits shorter mixing times. It is possible to carry out the mixing in two or more stages, and the mixing can be done in different apparatus, for example one stage in an internal mixer and one stage in an extruder. Total mixing time to achieve blends may vary depending on the particular silane selected or bonding agent, the relative amounts of elastomers in a given blend, and the degree of incorporation of silica desired.

It is possible to pre-treat the mineral filler with the bonding agent. Thus, for example, halobutyl elastomer, natural rubber, mineral filler and bonding agent may be added separately and then all be blended together. Alternatively the silica may be treated with the bonding agent prior to being blended with the halobutyl elastomer and natural rubber.

In another embodiment of the invention halobutyl elastomer, silica particles, silane and, optionally, processing oil extender are placed in a mixer such as a Banbury mixer, and mixed. It is preferred that the temperature of the mixing is not too high and preferably does not exceed about 160° C. Higher temperatures may cause curing to proceed undesirably far and impede subsequent processing. The product of mixing these four ingredients at a temperature not exceeding about 160° C. can be readily further processed on a warm mill with the addition of the natural rubber and the addition of further curatives such as sulfur as vulcanizing agent, zinc oxide as activator and magnesium oxide to raise basicity. Alternatively, the two elastomers, i.e., the natural rubber and the halogenated butyl elastomer may be admixed in one masterbatch with the other ingredients in the Banbury mixer before further processing.

Curing can be effected with sulfur as the vulcanizing agent. However, other curing agents can be used. For example, bis-dienophiles such as bis-maleimide, commercially available from DuPont under the trademark HVA 2 can be used as curring agents. Other commercially available ingredients that can be present in the masterbatch include processing aids such as aromatic oils (Sundex 790) and waxes (Sunolite® 240), antioxidants (Vulkanox® 4020 LG 6PPD and Vulkanox H5 Pastille (TMQ)), scorch inhibitors (Santogard PVI WGR-80%) and accelerators (Vulkacit® C₂/Eg-C(CBS).

The elastomer compositions of the present invention find many uses, such as use in tire tread compositions for vehicles, especially trucks and buses engine movements, shoes, rubber diaphragms such as for water pumps.

Important features of a tire tread composition are low rolling resistance, good traction, particularly when wet, and good abrasion resistance so that it is resistant to wear. Compositions of the invention display these desirable properties. Thus, an indicator of traction is tan δ at 0° C., with a high tan 8 at 0° C. correlating with good traction. An indicator of rolling resistance is tan δ at 60° C., with a low tan δ at 60° C. correlating with low rolling resistance. Rolling resistance is a measure of the resistance to forward movement of the tire, and low rolling resistance is desired to reduce fuel consumption. Low values of loss modulus E″ at 60° C. are also indicators of low rolling resistance. As is demonstrated in the examples below, compositions of the invention display high tan δ at 0° C., low tan δ at 60° C. and low loss modulus at 60° C.

The elastomeric compositions of this invention can be further mixed with other rubbers, for example, butadiene rubber, styrene-butadiene rubber and isoprene rubbers, and compounds contain these elastomers.

The invention is further illustrated in the following examples and the accompanying Figures.

### EXAMPLES

### Description of the Tests

The Abrasion resistance is DIN 53-516 (60 grit Emery paper)

### Dynamic Property Testing

Dynamic testing (Tan δ at 0° C. and 60° C., Loss modulus at 60° C.) was carried out using the Rheometrics RSA II. The RSA II is a dynamic mechanical analyzer for characterizing the properties of vulcanized elastomeric materials.

The dynamic mechanical properties give a measure of traction with the best traction usually obtained with high values of Tan δ at 0° C. Low values of Tan δ at 60° C., and in particular, low loss modulus at 60° C. are indicators of low rolling resistance.

Cure rheometry is ASTM D 52-89 MDR2000E, the Rheometer is at 30 arc and 1.7 Hz and the Permeability is ASTM D 14-34

### Description of Ingredients and General Mixing Procedure

HiSil® 233 -silica—a product of PPG

The halobutyl elastomer, natural rubber, silica and silane compounds were mixed in a model B Banbury mixer with a nominal volume of 1570 milliliters and using a fill factor of nominally 67% to 73% by volume. The starting temperature was 40° C.

At 0 minutes, the rubber was added to the Banbury followed by the oil+½ of the silica+½ of the silane. The ram was lowered and the Banbury turned on at 77rpm. At 1 minute, a ¼ of the silica was added. At 2 minutes, the remainder of the silica and the remainder of the silane were added. After 4 minutes the Banbury chute was swept. The products were mixed for a total of 6 minutes at 120-145° C. The compound was removed from the Banbury, and sheeted out on a warm mill set at 40° C. Curatives were then added to all or a portion of the compound on a mill set at 300° C.

### Example 1

Single masterbatches containing both brominated butyl rubber (BB 2040), natural rubber, silica, 3-aminopropyl- triethoxysilane and bis[3-(triethoxysilyl)propyl]tetrasulfane (Si 69) where prepared. The elastomers were used in the ratios 100/0, 90/10, 80/20, 70/30, 50/50, 25/75 and 0/100. The ratio of the two silanes was also varied, and one 50/50 blend of elastomers was prepared with no silane.

The components were mixed in a white “B” Banbury, utilizing a 6-minute mix. Dump temperatures varied between 120° C. and 140° C. for the components containing silanes. The compound containing no silane reached a dump temperature of 150° C.

The mixing conditions were;

0′ add BIIR+½ HiSil233+½ bonding agent

1′ add ¼ HiSil 233

2′ add ¼ HiSil 233+½ bonding agent

3-4′ sweep

6′ dump

The curatives, which were added on a cool mill, were

| | |
|---|---|
| Santogard PVI WGR-80% | 0.5 |
| NBS Sulfur | 1.8-1 |
| Vulkazit CZ/EG-C (CBS) | 1.8-1 |
| ZnO | 4-1 |

The complete formulations are given in Table 1.

TABLE 1

| | | | | | | | | |
|---|---|---|---|---|---|---|---|---|
| POLYSAR BROMOBUTYL | 0 | 10 | 20 | 30 | 50 | 75 | 100 | 50 |
| BB2040 (J-11575) | | | | | | | | |
| SMR CV60 NATURAL | 100 | 90 | 80 | 70 | 50 | 25 | 0 | 50 |
| RUBBER | | | | | | | | |
| HI-SIL 233 | 30 | 30 | 30 | 30 | 30 | 30 | 30 | 30 |
| MB 99CWX60 | 0 | 0.4 | 0.8 | 1.2 | 2 | 3 | 4 | 0 |
| SILANE SI-69 | 3 | 2.7 | 2.4 | 2.1 | 1.5 | 0.75 | 0 | 0 |
| STEARIC ACID | 2 | 2 | 2 | 2 | 2 | 2 | 2 | 2 |
| EMERSOL 132 NF | | | | | | | | |
| SUNDEX 790 | 4 | 4 | 4 | 4 | 4 | 4 | 4 | 4 |
| SUNOLITE 240 | 1.5 | 1.5 | 1.5 | 1.5 | 1.5 | 1.5 | 1.5 | 1.5 |
| VULKANOX 4020 LG (GPPD) | 2 | 2 | 2 | 2 | 2 | 2 | 2 | 2 |
| VULKANOX HS PASTILLE | 2 | 2 | 2 | 2 | 2 | 2 | 2 | 2 |
| (GRANULAR)(TMQ) | | | | | | | | |
| HI-SIL 233 | 15 | 15 | 15 | 15 | 15 | 15 | 15 | 15 |
| HI-SIL 233 | 15 | 15 | 15 | 15 | 15 | 15 | 15 | 15 |
| MB 99CWX60 | 0 | 0.4 | 0.8 | 1.2 | 2 | 3 | 4 | 0 |
| SILANE SI-69 | 3 | 2.7 | 2.4 | 2.1 | 1.5 | 0.8 | 0 | 0 |
| Total SI69 | 6 | 5.4 | 4.6 | 4.2 | 3.0 | 1.5 | 0.0 | 0.0 |
| Total amino propyl triethoxy | 0 | 0.8 | 1.6 | 2.4 | 4.0 | 6.0 | 8.0 | 0.0 |
| silane (MB 99CWX60) | | | | | | | | |
| Total HiSil 233 | 60 | 60 | 60 | 60 | 60 | 60 | 60 | 60 |
| SANTOGARD PVI | 0.50 | 0.50 | 0.50 | 0.50 | 0.50 | 0.50 | 0.50 | 0.50 |
| (PELLETIZED) WGR-80% | | | | | | | | |
| SULFUR NBS | 1.80 | 1.72 | 1.64 | 1.56 | 1.40 | 1.20 | 1.00 | 1.40 |
| VULKACIT CZ/EG-C (CBS) | 1.80 | 1.72 | 1.64 | 1.56 | 1.40 | 1.20 | 1.00 | 1.40 |
| ZINC OXIDE (KADOX 920) | 4.00 | 3.70 | 3.40 | 3.10 | 2.50 | 1.75 | 1.00 | 2.50 |
| GRADE PC 216 (C&PT STD) | | | | | | | | |

### Example 2

Single masterbatches containing either natural rubber (NR) or 80% NR+20% BB2040, silica (HiSil 233), and either TESPD or a combination of TESPD+APTES were prepared. One masterbatch containing NR, and carbon black (N-110) was prepared.

The actual recipes are given in Table 2

TABLE 2

| | A | B | C |
|---|---|---|---|
| NR (SMR CV60) | 100 | 100 | 100 |
| C-Black N-110 | 50 | | |
| HiSil 233 | | 60 | 60 |
| Silane S-1589 (TESPD) | | 6.9 | 8.6 |
| Silane APTES | | 1.6 | |
| Stearic acid | 2 | 2 | 2 |
| Sundex 790 (Ar. Oil) | 4 | 4 | 4 |
| Sunolite 240 (Wax) | 1.5 | 1.5 | 1.5 |
| Vulkanox 4020/LG (6PPD) | 2 | 2 | 2 |
| Vulkanox HS Past. (TMQ) | 2 | 2 | 2 |
| ZnO | 4 | 4* | 4* |
| Dump temp.(° C.) | ND | 140-5 | 130 |
| @10 min. | | | |

*ZnO in the silica mixes was added with the other curatives on a cool mill (see below).

The mixing conditions for A were:

| | |
|---|---|
| 0′ | add NR + carbon black |
| 1′ | add StH + Sundex 790 + Sunolite 240 + 6PPD + TMQ + ZnO |
| 2-3′ | sweep |
| 6′ | dump or @ 150° C. |

The mixing conditions for B-C were:

| | |
|---|---|
| 0′ | add NR + ½ Hisil 233 + ½ silanes + StH + Sundex 790 + |
| | Sunolite 240 + 6PPD + TMQ |
| 1′ | add ¼ HiSil 233 |
| 2′ | add ¼ HiSil 233 + ½ silanes |
| 3-4′ | sweep |
| 10′ | dump |

C was remixed the next day for a further 6 minutes in the Banbury.

Three different curative systems, which were added on a cool mill, were examined. A is a typical truck tread curative system, B is a high sulfur cure system and C is a Vulcuren® based system. The curative systems are given in Table 3:

TABLE 3

| Cure system | A | B | C |
|---|---|---|---|
| Santogard PVI WGR-80% | 0.5 | 0.5 | 0.5 |
| ZnO | 4 | 4 | 4 |
| Vulkazit CZ/EGC (CBS) | | | |
| NBS Sulfur | 1.75 | 3.0 | 0.5 |
| Vulcuren ® KA 9188* | | | 2.5 |

*available from Bayer AG

The effect of adding 20% BB2040 to NR is shown in Table 4.

TABLE 4

| COMPOUND No. | 1 | 2 | 3 | 4 | 5 | 6 | 7 | 8 | 9 |
|---|---|---|---|---|---|---|---|---|---|
| | 100 NR | 80 NR | 100 NR | 80 NR | 100 NR | 80 NR | 100 NR | 80 NR | 100 NR |
| Filler | HiSil233 | HiSil233 | HiSil233 | HiSil233 | HiSil233 | HiSil233 | HiSil233 | HiSil233 | N-110 |
| RECIPE: | B | B | C | C | B | B | B | B | A |
| BANBURY MIX TIME: | 10 | 10 | 10 + 6 | 10 + 6 | 10 | 10 | 10 | 10 | 6 |
| CURATIVES: | A | A | A | A | B | B | C | C | A |

MDR CURE CHARACTERISTICS (1.7 Hz, 3°arc, 60′ @ 170° C., charts 1180-1195)

| | | | | | | | | | |
|---|---|---|---|---|---|---|---|---|---|
| MH (dN.m) | 49.8 | 53.1 | 47.9 | 53.1 | 38.4 | 40.6 | 59.7 | 68.1 | 43.5 |
| ML (dN.m) | 4.7 | 6.9 | 2.8 | 5.6 | 5.4 | 7.8 | 4.6 | 6.9 | 2.1 |
| ts 2 (min) | 1.92 | 1.32 | 2.16 | 0.96 | 1.62 | 1.14 | 2.4 | 2.04 | 1.44 |
| t′ 50 (min) | 3.64 | 3.87 | 3.86 | 3.96 | 2.93 | 3.44 | 3.52 | 3.72 | 2.71 |
| t′ 90 (min) | 4.4 | 4.78 | 4.9 | 5.28 | 4.59 | 5.35 | 11.98 | 30.76 | 3.44 |

COMPOUND MOONEY SCORCH (Large rotor, 135° C.)

| | | | | | | | | | |
|---|---|---|---|---|---|---|---|---|---|
| t Value t05 (min) | >30 | >30 | >30 | >30 | >30 | >30 | 27.57 | 26.9 | 26.09 |
| CPML 1 + 8 @ 125° C. | 17 | 25 | 10 | 19 | 19 | 27 | 17 | 25 | 12 |

STRESS STRAIN (Die C DUMBELLS, t90 + 5 @ 170° C., tested @ 23° C.)

| | | | | | | | | | |
|---|---|---|---|---|---|---|---|---|---|
| Hard. Shore A2 Inst. (pts.) | 64 | 66 | 70 | 69 | 66 | 64 | 70 | 71 | 70 |
| Ultimate Tensile (MPa) | 27.6 | 24.3 | 26.7 | 22.7 | 22.27 | 23.45 | 27.43 | 19.8 | 23.8 |
| Ultimate Elongation (%) | 580 | 527 | 607 | 522 | 579 | 594 | 469 | 353 | 581 |
| Stress @ 100 (MPa) | 2.23 | 2.84 | 2.46 | 2.82 | 2.03 | 2.41 | 3.42 | 3.6 | 1.67 |
| Stress @ 300 (MPa) | 10.94 | 12.25 | 10.5 | 11.61 | 8.66 | 9.63 | 16.36 | 16.09 | 8.5 |
| 300M/100M | 4.9 | 4.3 | 4.3 | 4.1 | 4.3 | 4.0 | 4.8 | 4.5 | 5.1 |
| Tear Strength (kN/m) | 100.3 | 81.9 | 103.3 | 97.3 | 86.3 | 95.3 | 66.9 | 49.6 | 91.7 |

GOODRICH FLEXOMETER (cure tc90 + 10 @ 170° C., tested @ 55° C., 11 kg on beam, 17.5% stroke compression)

| | | | | | | | | | |
|---|---|---|---|---|---|---|---|---|---|
| Heat Rise (° C.) | 17 | 18 | 19 | 18 | 28 | 22 | 16 | 17 | 23 |
| Permanent Set (%) | 2.6 | 2.5 | 3.4 | 2.6 | 8.5 | 4.8 | 1.7 | 1.3 | 4.2 |

RSA II, TEMPERATURE SWEEP (2° C./min, 60 sec soak, 70 rad/s, −100 to +100° C., cured tc90 + 5 @ 170° C.)

| | | | | | | | | | |
|---|---|---|---|---|---|---|---|---|---|
| Tan delta @ 0° C. | 0.112 | 0.193 | 0.109 | 0.167 | 0.149 | 0.207 | 0.090 | 0.153 | 0.129 |
| Tan delta @ 60° C. | 0.080 | 0.100 | 0.088 | 0.088 | 0.123 | 0.111 | 0.078 | 0.084 | 0.113 |
| Loss modulus @ 60° C. | 1.96 | 2.22 | 2.75 | 2.26 | 2.15 | 1.86 | 2.58 | 1.99 | 2.38 |

DIN ABRASION (cure tc90 + 10 @ 170° C.)

| | | | | | | | | | |
|---|---|---|---|---|---|---|---|---|---|
| Volume Loss (mm³) | 143 | 134 | 141 | 136 | 178 | 143 | 133 | 148 | 166 |

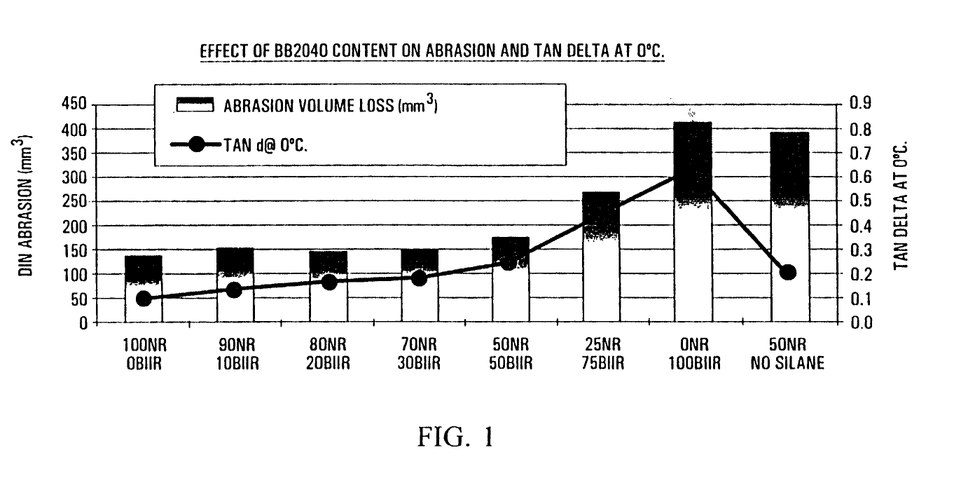

The effect of addition of BB2040 to natural rubber on abrasion and tan δ at 0° C. is shown in FIG. 1. As can be seen, addition of the halobutyl elastomer to natural rubber in amounts up to 30% has no effect on abrasion resistance, but tan δ at 0° C. is increased from 0.11 to 0.19, indicating a significant improvement in wet traction without any adverse effect on abrasion resistance.

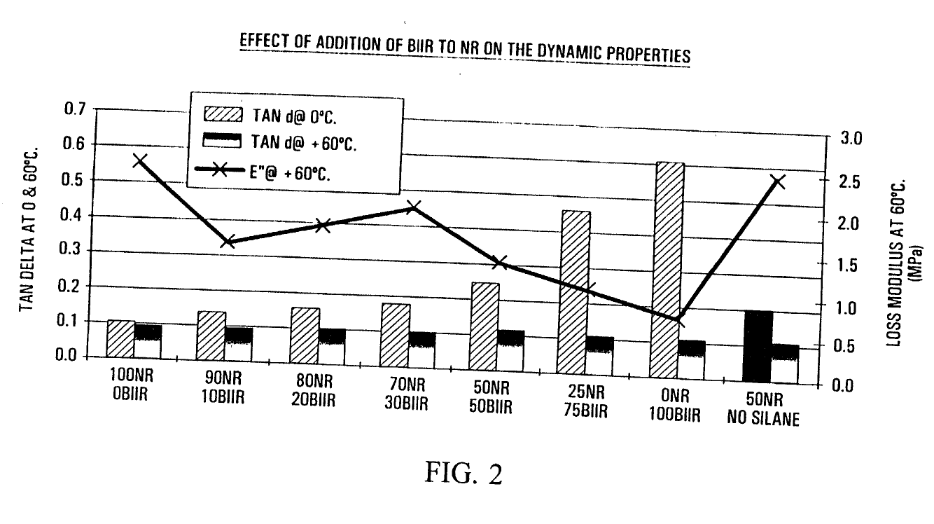

The effect of addition of BB2040 to natural rubber on the dynamic properties is shown in FIG. 2. This shows tan δ at 0° C. increasing with the halobutyl elastomer content, again indicating an increase in wet traction. Tan δ at 60° C. remains constant but the loss modulus E″ ranges between 1.47 and 1.96 with amounts of halobutyl elastomer from 10 to 30%. These values compare favorably with a value of E″ of 2.36 for 100% natural rubber.

The effect of adding 20% BB2040 to NR is shown in Table 4. Comparison of 1 with 2, 3 with 4, 5 with 6, 7 with 8 shows in all cases a significant increase in tan delta at 0° C. indicating an improvement in wet traction. Concurrently there is an improvement in DIN abrasion resistance for 3 of the 4 pairs of data, and all the compounds containing silica show an improvement in DIN compared to the NR carbon black filled compound (number 9). Tan delta and loss modulus at 60° C. are similar.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An elastomeric composition comprising a natural rubber, a halobutyl elastomer, a mineral filler, and a rubber-mineral filler bonding agent.

2. A composition according to claim 1 wherein the halobutyl elastomer is a bromobutyl elastomer and the mineral filler is silica.

3. A composition according to claim 1 wherein the bonding agent is a silane.

4. A composition according to claim 1 wherein the composition is cured with sulfur.

5. A composition according to claim 1 wherein the halobutyl elastomer constitutes from 5 to 50% of the elastomeric content of the composition.

6. A composition according to claim 5 wherein the halobutyl elastomer constitutes from 5 to 30% of the elastomeric content of the composition.

7. A process for preparing an elastomeric comprising blending a natural rubber, a halobutyl elastomer, a mineral filler and a rubber-mineral filler bonding agent.

8. A process according to claim 7 wherein the natural rubber, the halobutyl elastomer, the mineral filler and the bonding agent are added separately.

9. A process according to claim 7 wherein the mineral filler is silica and the bonding agent is a silane that has at least one hydroxyl group or hydrolyzable group attached to a silicon atom of the silane.

10. A process according to claim 9 wherein the silane is aminopropyltriethoxysilane, bis[3-(triethoxysilyl)propyl]-tetrasulfane, bis[3-(triethoxysilyl)propyl]disulfane or mercaptopropyl trimethoxysilane, or a mixture thereof.

11. A cured, filled elastomeric composition according to claim 1 in the form of a tire tread for a vehicle.

12. A cured, filled elastomeric composition according to claim 1 in the form of a tire tread for a truck.

13. A cured, filled elastomeric composition according to claim 1 in the form of an engine mount, a shoe sole or a diaphragm for a pump.
